(19) United States
(12) Patent Application Publication
(10) Pub. No.: US 2023/0272808 A1
(43) Pub. Date: Aug. 31, 2023

(54) PRESSURIZED FLUID SUPPLY SYSTEM

(71) Applicant: FANUC CORPORATION, Minamitsuru-gun (JP)

(72) Inventors: Makito NAKAMURA, Minamitsuru-gun, Yamanashi-ken (JP); Masahiro MUROTA, Minamitsuru-gun, Yamanashi-ken (JP)

(21) Appl. No.: 18/018,246

(22) PCT Filed: Jul. 27, 2021
(86) PCT No.: PCT/JP2021/027621

§ 371 Date: Jan. 26, 2023

(30) Foreign Application Priority Data
Jul. 30, 2020 (JP) 2020-129028

(51) Int. Cl. F15B 13/02; F15B 19/00

(52) U.S. Cl. CPC F15B 13/021; F15B 19/005; F15B 2211/4053

(57) ABSTRACT

A pressurized fluid supply system capable of favorably resuming the supply of a pressurized fluid to a support member when the supply of the pressurized fluid from a fluid supply source returns to a normal state, includes: a fluid supply path for supplying the pressurized fluid from the fluid supply source to the support member that supports a member using the pressurized fluid; a solenoid valve provided on the fluid supply path; a pressure sensor that is provided on the fluid supply path between the fluid supply source and the solenoid valve and detects the pressure of the pressurized fluid; a flow rate sensor that is provided on the fluid supply path between the solenoid valve and the support member and detects the flow rate of the pressurized fluid; and a control unit that controls opening/closing of the solenoid valve.

### TECHNICAL FIELD

The present invention relates to a pressurized fluid supply system.

### BACKGROUND ART

JP 2018-109429 A discloses a static pressure bearing device including: a rotating body including a spindle; and a bearing main body portion disposed radially outside the spindle so as to surround the spindle.

### SUMMARY OF THE INVENTION

When supply of a pressurized fluid from a fluid supply source to the static pressure bearing is disrupted, damage to the spindle is liable to occur. It is conceivable to take measures to avoid the above situation, by providing a solenoid valve, a sensor, etc., in a fluid supply path through which the pressurized fluid is supplied. However, in a case where the solenoid valve, the sensor, etc. are simply provided in the fluid supply path, even when the supply of the pressurized fluid from the fluid supply source returns to a normal state, the supply of the pressurized fluid to the static pressure bearing cannot be satisfactorily resumed.

An object of the present invention is to provide a pressurized fluid supply system in which supply of pressurized fluid to a support unit can be satisfactorily resumed when the supply of the pressurized fluid from the fluid supply source returns to normal.

According to an aspect of the present invention, there is provided a pressurized fluid supply system including: a fluid supply path configured to allow a pressurized fluid from a fluid supply source to be supplied to a support unit configured to support a member using the pressurized fluid; a solenoid valve provided on the fluid supply path; a pressure sensor provided on the fluid supply path between the fluid supply source and the solenoid valve and configured to detect a pressure of the pressurized fluid; a flow sensor provided on the fluid supply path between the solenoid valve and the support unit and configured to detect a flow rate of the pressurized fluid; and a control unit configured to control opening and closing of the solenoid valve.

According to the present invention, it is possible to provide the pressurized fluid supply system in which the supply of the pressurized fluid to the support unit can be satisfactorily resumed when the supply of the pressurized fluid from the fluid supply source has returned to normal.

### BRIEF DESCRIPTION OF DRAWINGS

FIG. 1 is a block diagram illustrating a pressurized fluid supply system according to a first embodiment;

FIG. 2A is a diagram illustrating an example of arrangement of a pressure sensor, a flow sensor, and a solenoid valve;

FIG. 2B is a diagram illustrating an example of arrangement of a pressure sensor, a flow sensor, and a solenoid valve;

FIG. 2C is a diagram illustrating an example of arrangement of a pressure sensor, a flow sensor, and a solenoid valve;

FIG. 2D is a diagram illustrating an example of arrangement of a pressure sensor, a flow sensor, and a solenoid valve;

FIG. 2E is a diagram illustrating an example of arrangement of a pressure sensor, a flow sensor, and a solenoid valve;

FIG. 2F is a diagram illustrating an example of arrangement of a pressure sensor, a flow sensor, and a solenoid valve;

FIG. 3 is a flowchart showing an example of operation of the pressurized fluid supply system according to the first embodiment;

FIG. 4 is a block diagram illustrating a pressurized fluid supply system according to a second embodiment;

FIG. 5 is a flowchart showing an example of operation of the pressurized fluid supply system according to the second embodiment;

FIG. 6A is a block diagram illustrating a pressurized fluid supply system according to a third embodiment;

FIG. 6B is a block diagram illustrating a pressurized fluid supply system according to a third embodiment; and

FIG. 7 is a graph showing an evaluation result.

### DETAILED DESCRIPTION OF THE INVENTION

A pressurized fluid supply system according to the present invention will be described in detail below by way of preferred embodiments and with reference to the accompanying drawings.

### First Embodiment

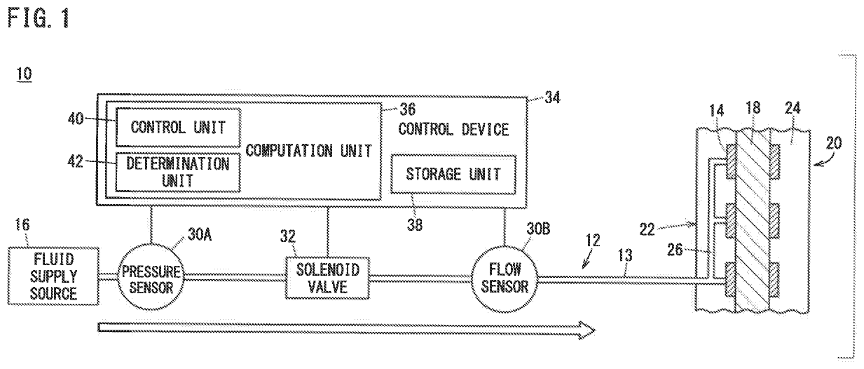

A pressurized fluid supply system according to a first embodiment will be described with reference to FIGS. 1 to 3.

As shown in FIG. 1, the pressurized fluid supply system 10 according to the present embodiment includes a fluid supply path 12. The fluid supply path 12 allows a pressurized fluid from a fluid supply source 16 to be supplied to a support unit (a support member) 14 described below. Here, a case where the pressurized fluid is a pressurized gas will be described as an example, but the present invention is not limited thereto. The pressurized fluid may be a pressurized liquid. The liquid may include, but is not limited to, water, oil and the like. The support unit 14 may support a member 18 described below, using a pressurized fluid. The length of the fluid supply path 12 is, for example, about 2 to 3 meters, but is not limited thereto. The inner diameter of the fluid supply path 12 is, for example, about 4.5 mm, but is not limited thereto. The fluid supply path 12 is configured by a pipe 13.

The fluid supply source 16 includes, for example, a compressor (not illustrated), a regulator (not illustrated), and the like. The fluid supply source 16 may supply pressurized fluid to the support unit 14 via the fluid supply path 12.

The support unit 14 may support a member 18 using the pressurized fluid supplied from the fluid supply source 16. More specifically, the support unit 14 may rotatably or slidably support the member 18 using the pressurized fluid supplied from the fluid supply source 16. The support unit 14 is, for example, a static pressure bearing, but is not limited thereto. The member 18 is, for example, a shaft, but is not limited thereto. Here, a case where the support unit 14 and the member 18 are provided on a spindle 22 of a machine tool 20 will be described as an example, but the present invention is not limited thereto.

The spindle 22 is provided with a housing 24. A gas supply passage 26 communicating with the fluid supply path 12 is formed in the housing 24. Pressurized fluid may be supplied to the support unit 14, i.e., the static pressure bearing, via the gas supply passage 26. That is, the pressurized fluid can be supplied to the static pressure bearing via the gas supply passage 26. Although the spindle 22 is provided with components other than these components, the description thereof is omitted here.

A solenoid valve 32 is provided on the fluid supply path 12 between the fluid supply source 16 and the support unit 14. The solenoid valve 32 is, for example, a normally-closed solenoid valve, but is not limited thereto.

A sensor 30A (pressure sensor 30A) is provided on the fluid supply path 12 between the fluid supply source 16 and the solenoid valve 32. The pressure sensor 30A may detect the pressure of the pressurized fluid supplied from the fluid supply source 16.

A sensor 30B (flow sensor 30B) is provided on the fluid supply path 12 between the solenoid valve 32 and the support unit 14. The flow sensor 30B may detect the flow rate of the pressurized fluid. Reference numeral 30 is used to express the sensors collectively, and reference numerals 30A and 30B are used to describe the individual sensors.

The pressurized fluid supply system 10 is further provided with a control device 34. The control device 34 is equipped with a computation unit 36 and a storage unit 38. The computation unit 36 may be configured by a processor such as a CPU (Central Processing Unit) or the like, however the present invention is not limited to this feature. The computation unit 36 includes a control unit 40 and a determination unit 42. The control unit 40 and the determination unit 42 can be realized by the computation unit 36 executing a program stored in the storage unit 38.

The storage unit 38 is equipped with a volatile memory and a nonvolatile memory, neither of which are shown. As examples of the volatile memory, there may be cited a RAM (Random Access Memory) or the like. As examples of the nonvolatile memory, there may be cited a ROM (Read Only Memory), a flash memory, or the like. Programs, data, and the like may be stored in the storage unit 38. Data indicating a normal pressure range of the pressure detected by the pressure sensor 30A and data indicating a normal flow rate range of the flow rate detected by the flow sensor 30B may be stored in advance in the storage unit 38.

The control unit 40 performs overall control of the control device 34. The control unit 40 can control opening and closing of the solenoid valve 32.

The determination unit 42 can determine whether or not the pressure detected by the pressure sensor 30A is within the normal range (the normal pressure range). The determination unit 42 can determine whether or not the flow rate detected by the flow sensor 30B is within the normal range (the normal flow rate range). When the determination unit 42 determines that the detection value detected by one of the sensors 30 is outside the normal range, the control unit 40 may close the solenoid valve 32. When the detection value detected by the sensor 30 located on the upstream side of the solenoid valve 32 falls within the normal range after the solenoid valve 32 has been closed, the control unit 40 opens the solenoid valve 32. That is, when the detection value detected by the sensor 30 located on the upstream side of the solenoid valve 32 is out of the normal range, the control unit 40 does not open the solenoid valve 32. This is to prevent a failure from affecting the downstream side of the solenoid valve 32. Even though the detection value detected by the sensor 30 located on the downstream side of the solenoid valve 32 is out of the normal range after the solenoid valve 32 has been closed, the control unit 40 may open the solenoid valve 32 if the detection value detected by the sensor 30 located on the upstream side of the solenoid valve 32 is within the normal range. However, even though a predetermined time has already elapsed since the solenoid valve 32 was opened, if the detection value detected by the sensor 30 located on the downstream side of the solenoid valve 32 still remains outside the normal range, then the control unit 40 closes the solenoid valve 32 again.

In the present embodiment, the pressure sensor 30A is located between the fluid supply source 16 and the solenoid valve 32, and the flow sensor 30B is located between the solenoid valve 32 and the support unit 14. That is, in the present embodiment, the pressure sensor 30A, the solenoid valve 32, and the flow sensor 30B are arranged in this order from the upstream side to the downstream side. The reason why these components are arranged in this order in the present embodiment is as follows.

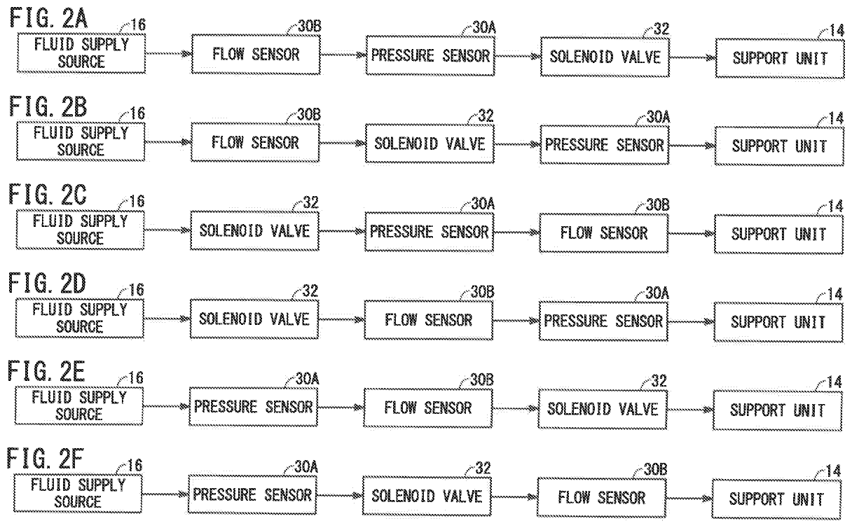

FIGS. 2A to 2F are diagrams illustrating an example of arrangement of the pressure sensor, the flow sensor, and the solenoid valve.

In the example shown in FIG. 2A, that is, in Comparative Example 1, the flow sensor 30B, the pressure sensor 30A, and the solenoid valve 32 are arranged in this order from the upstream side to the downstream side. As described above, when the detection value detected by one of the sensors 30 is out of the normal range for some reason, the solenoid valve 32 is closed. When the solenoid valve 32 is closed, the flow of the pressurized fluid is blocked by the closed solenoid valve 32. Therefore, in the example shown in FIG. 2A, even though the supply of the pressurized fluid from the fluid supply source 16 returns to normal after the solenoid valve 32 has been closed, the flow rate detected by the flow sensor 30B does not fall within the normal flow rate range. As described above, when the detection value detected by the sensor 30 located on the upstream side of the solenoid valve 32 is out of the normal range, the control unit 40 does not open the solenoid valve 32. In the example shown in FIG. 2A, the two sensors 30 are positioned on the upstream side of the solenoid valve 32, and when at least one of the detection values detected by the two sensors 30 is out of the normal range, the control unit 40 does not open the solenoid valve 32. Therefore, in the example shown in FIG. 2A, even though the supply of the pressurized fluid from the fluid supply source 16 returns to normal after the solenoid valve 32 has been closed, the solenoid valve 32 is not opened, and the supply of the pressurized fluid to the support unit 14 cannot be satisfactorily resumed.

In the example shown in FIG. 2B, i.e., in Comparative Example 2, the flow sensor 30B, the solenoid valve 32, and the pressure sensor 30A are arranged in this order from the upstream side to the downstream side. As described above, when the detection value detected by one of the sensors 30 is out of the normal range for some reason, the solenoid valve 32 is closed. When the solenoid valve 32 is closed, the flow of the pressurized fluid is blocked by the closed solenoid valve 32. Therefore, in the example shown in FIG. 2B, even though the supply of the pressurized fluid from the fluid supply source 16 returns to normal after the solenoid valve 32 has been closed, the flow rate detected by the flow sensor 30B does not fall within the normal flow rate range. In addition, the pressure detected by the pressure sensor 30A does not fall within the normal pressure range. As described above, when the detection value detected by the sensor 30 located on the upstream side of the solenoid valve 32 is out of the normal range, the control unit 40 does not open the solenoid valve 32. Therefore, in the example shown in FIG. 2B, even though the supply of the pressurized fluid from the fluid supply source 16 returns to normal after the solenoid valve 32 has been closed, the solenoid valve 32 is not opened, and the supply of the pressurized fluid to the support unit 14 cannot be satisfactorily resumed.

In the example shown in FIG. 2C, that is, in Comparative Example 3, the solenoid valve 32, the pressure sensor 30A, and the flow sensor 30B are arranged in this order from the upstream side to the downstream side. As described above, when the detection value detected by one of the sensors 30 is out of the normal range for some reason, the solenoid valve 32 is closed. When the solenoid valve 32 is closed, the flow of the pressurized fluid is blocked by the closed solenoid valve 32. Since the supply of the pressurized fluid to the pressure sensor 30A is blocked by the solenoid valve 32, in the example shown in FIG. 2C, the pressure sensor 30A cannot detect whether or not the pressure of the pressurized fluid supplied from the fluid supply source 16 has returned to normal. Therefore, in the example shown in FIG. 2C, even though the supply of the pressurized fluid from the fluid supply source 16 returns to normal after the solenoid valve 32 has been closed, the supply of the pressurized fluid to the support unit 14 cannot be satisfactorily resumed.

In the example shown in FIG. 2D, that is, in Comparative Example 4, the solenoid valve 32, the flow sensor 30B, and the pressure sensor 30A are arranged in this order from the upstream side to the downstream side. As described above, when the detection value detected by one of the sensors 30 is out of the normal range for some reason, the solenoid valve 32 is closed. When the solenoid valve 32 is closed, the flow of the pressurized fluid is blocked by the closed solenoid valve 32. Since the supply of the pressurized fluid to the pressure sensor 30A is blocked by the solenoid valve 32, in the example shown in FIG. 2D, the pressure sensor 30A cannot detect whether or not the pressure of the pressurized fluid supplied from the fluid supply source 16 has returned to normal. Therefore, in the example shown in FIG. 2D, even though the supply of the pressurized fluid from the fluid supply source 16 returns to normal after the solenoid valve 32 has been closed, the supply of the pressurized fluid to the support unit 14 cannot be satisfactorily resumed.

In the example shown in FIG. 2E, i.e., in Comparative Example 5, the pressure sensor 30A, the flow sensor 30B, and the solenoid valve 32 are arranged in this order from the upstream side to the downstream side. As described above, when the detection value detected by one of the sensors 30 is out of the normal range for some reason, the solenoid valve 32 is closed. When the solenoid valve 32 is closed, the flow of the pressurized fluid is blocked by the closed solenoid valve 32. Therefore, even though the supply of the pressurized fluid from the fluid supply source 16 returns to normal after the solenoid valve 32 has been closed, the flow rate detected by the flow sensor 30B does not fall within the normal flow rate range. As described above, when the detection value detected by the sensor 30 located on the upstream side of the solenoid valve 32 is out of the normal range, the control unit 40 does not open the solenoid valve 32. In the example shown in FIG. 2E, the two sensors 30 are positioned on the upstream side of the solenoid valve 32, and when at least one of the detection values detected by the two sensors 30 is out of the normal range, the control unit 40 does not open the solenoid valve 32. Therefore, in the example shown in FIG. 2E, even though the supply of the pressurized fluid from the fluid supply source 16 returns to normal after the solenoid valve 32 has been closed, the solenoid valve 32 is not opened, and the supply of the pressurized fluid to the support unit 14 cannot be satisfactorily resumed.

In the example shown in FIG. 2F, that is, in the present embodiment, the pressure sensor 30A, the solenoid valve 32, and the flow sensor 30B are arranged in this order from the upstream side to the downstream side. As described above, when the detection value detected by one of the sensors 30 is out of the normal range for some reason, the solenoid valve 32 is closed. Since the pressure sensor 30A is located between the fluid supply source 16 and the solenoid valve 32, in the example shown in FIG. 2F, the pressure sensor 30A can detect whether or not the supply of the pressurized fluid from the fluid supply source 16 has returned to normal. When the supply of the pressurized fluid from the fluid supply source 16 has returned to normal, the pressure detected by the pressure sensor 30A falls within the normal pressure range. In the example shown in FIG. 2F, of the sensors 30, only the pressure sensor 30A is located upstream of the solenoid valve 32. That is, in the example shown in FIG. 2F, the sensor 30 whose detection value is out of the normal range even though the supply of the pressurized fluid from the fluid supply source 16 has returned to normal does not exist on the upstream side of the solenoid valve 32. Therefore, in the example shown in FIG. 2F, if the supply of the pressurized fluid from the fluid supply source 16 returns to normal after closing of the solenoid valve 32, the solenoid valve 32 is opened. When the solenoid valve 32 is opened, the flow rate of the pressurized fluid detected by the flow sensor 30B falls within the normal flow rate range. As described above, in the example shown in FIG. 2F, that is, in the present embodiment, if the supply of the pressurized fluid from the fluid supply source 16 returns to normal after closing of the solenoid valve 32, the solenoid valve 32 is opened and the supply of the pressurized fluid to the support unit 14 can be satisfactorily resumed.

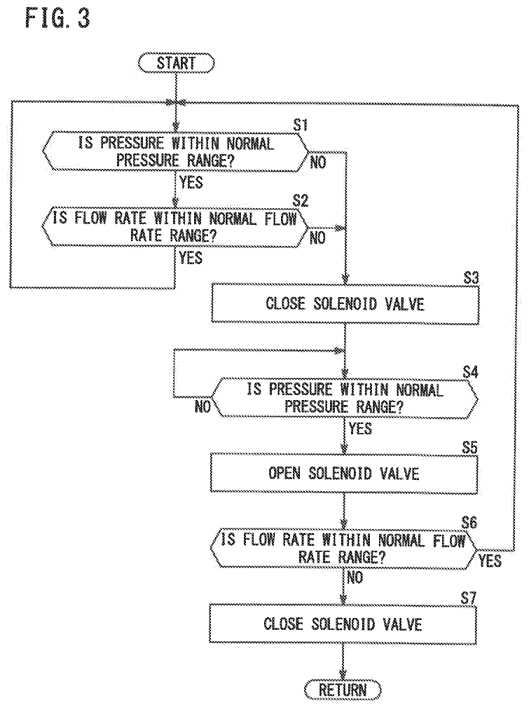

FIG. 3 is a flowchart illustrating an example of the operation of the pressurized fluid supply system according to the present embodiment.

In step S1, the determination unit 42 determines whether or not the pressure detected by the pressure sensor 30A is within the normal pressure range. When the pressure detected by the pressure sensor 30A is within the normal pressure range (YES in step S1), the process proceeds to step S2. When the pressure detected by the pressure sensor 30A is outside the normal pressure range (NO in step S1), the process proceeds to step S3.

In step S2, the determination unit 42 determines whether or not the flow rate detected by the flow sensor 30B is within the normal flow rate range. When the flow rate detected by the flow sensor 30B is within the normal flow rate range (YES in step S2), the steps subsequent to step S1 are repeated. When the flow rate detected by the flow sensor 30B is out of the normal flow rate range (NO in step S2), the process proceeds to step S3.

In step S3, the control unit 40 closes the solenoid valve 32. Thereafter, the process transitions to step S4.

In step S4, the determination unit 42 determines whether or not the pressure detected by the pressure sensor 30A is within the normal pressure range. When the pressure detected by the pressure sensor 30A is within the normal pressure range (YES in step S4), the process proceeds to step S5. If the pressure detected by the pressure sensor 30A is outside the normal pressure range (NO in step S4), step S4 is repeated.

In step S5, the control unit 40 opens the solenoid valve 32. Thereafter, the process transitions to step S6.

In step S6, the determination unit 42 determines whether or not the flow rate detected by the flow sensor 30B is within the normal flow rate range. When the flow rate detected by the flow sensor 30B falls within the normal flow rate range (YES in step S6), the steps subsequent to step S1 are repeated. If the flow rate detected by the flow sensor 30B remains outside the normal flow rate range even after the predetermined time has elapsed since the solenoid valve 32 was opened (NO in step S6), the process proceeds to step S7.

In step S7, the control unit 40 closes the solenoid valve 32. In this way, the process shown in FIG. 3 is completed.

As described above, according to the present embodiment, the pressure sensor 30A is provided on the fluid supply path 12 between the fluid supply source 16 and the solenoid valve 32, and the flow sensor 30B is provided on the fluid supply path 12 between the solenoid valve 32 and the support unit 14. When the detection value detected by one of the sensors 30 is out of the normal range for some reason, the solenoid valve 32 is closed. Since the pressure sensor 30A is located between the fluid supply source 16 and the solenoid valve 32, in the present embodiment, the pressure sensor 30A can detect whether or not the supply of the pressurized fluid from the fluid supply source 16 has returned to normal. When the supply of the pressurized fluid from the fluid supply source 16 has returned to normal, the pressure detected by the pressure sensor 30A falls within the normal pressure range. In this embodiment, of the sensors 30, only the pressure sensor 30A is located upstream of the solenoid valve 32. That is, in the present embodiment, the sensor 30 whose detection value is out of the normal range even though the supply of the pressurized fluid from the fluid supply source 16 has returned to normal does not exist on the upstream side of the solenoid valve 32. Therefore, in the present embodiment, if the supply of the pressurized fluid from the fluid supply source 16 returns to normal after closing of the solenoid valve 32, the solenoid valve 32 is opened. When the solenoid valve 32 is opened, the flow rate of the pressurized fluid detected by the flow sensor 30B falls within the normal flow rate range. As described above, in the present embodiment, if the supply of the pressurized fluid from the fluid supply source 16 returns to normal after closing of the solenoid valve 32, the solenoid valve 32 is opened and the supply of the pressurized fluid to the support unit 14 can be satisfactorily resumed. As described above, according to the present embodiment, it is possible to provide the pressurized fluid supply system 10 in which the supply of the pressurized fluid to the support unit 14 can be satisfactorily resumed when the supply of the pressurized fluid from the fluid supply source 16 returns to normal.

### Second Embodiment

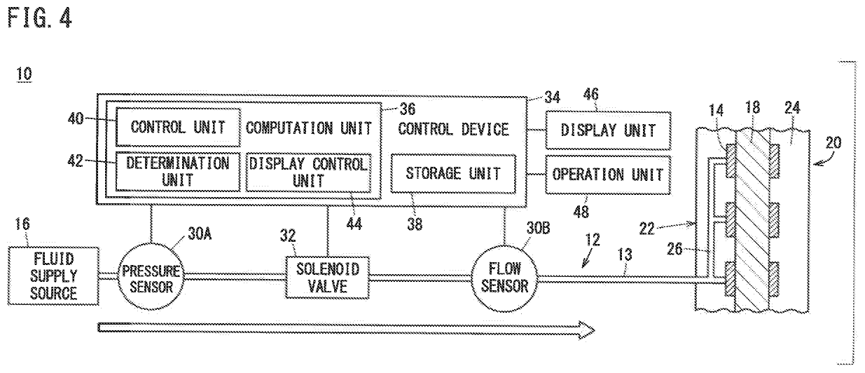

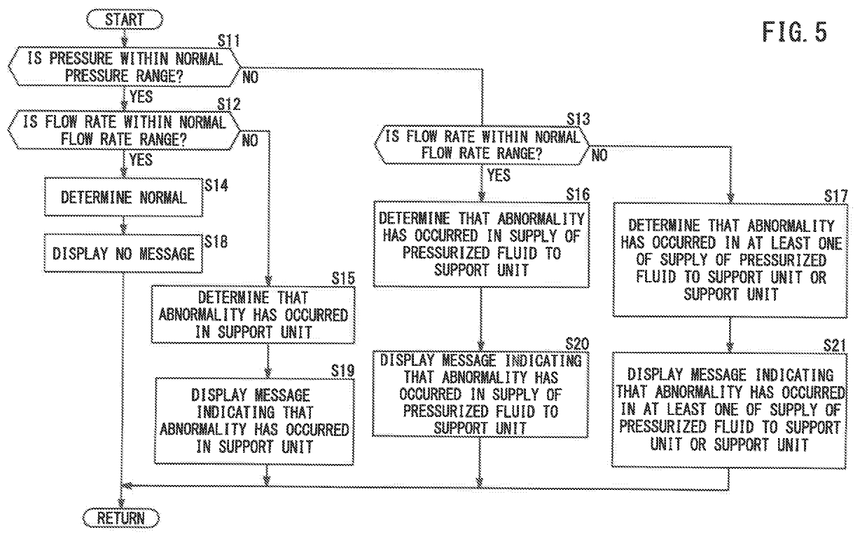

A pressurized fluid supply system according to a second embodiment will be described with reference to FIGS. 4 and 5. The same constituent elements as those of the pressurized fluid supply system according to the first embodiment shown in FIGS. 1 to 3 are designated by the same reference numerals, and description of such features will be omitted or referred to in an abbreviated manner. FIG. 4 is a block diagram illustrating the pressurized fluid supply system according to the present embodiment.

The pressurized fluid supply system 10 according to the present embodiment can determine the details of the abnormality based on the pressure detected by the pressure sensor 30A and the flow rate detected by the flow sensor 30B.

The determination unit 42 can make a determination as will be described later, based on the pressure detected by the pressure sensor 30A and the flow rate detected by the flow sensor 30B.

A display unit 46 may be connected to the control device 34. A display control unit 44 can display the pressure detected by the pressure sensor 30A on the display screen of the display unit 46. The display control unit 44 can display whether or not the pressure detected by the pressure sensor 30A is within the normal pressure range, on the display screen of the display unit 46. The display control unit 44 can display the flow rate detected by the flow sensor 30B on the display screen of the display unit 46. In addition, the display control unit 44 can display whether or not the flow rate detected by the flow sensor 30B is within the normal flow rate range, on the display screen of the display unit 46. The display unit 46 can be constituted, for example, by a liquid crystal display or the like, however the present invention is not limited to this feature.

An operation unit 48 may be connected to the control device 34. The operation unit 48 can be constituted, for example, by a keyboard, a mouse, or the like, however the present invention is not limited to this feature. The operation unit 48 may be constituted by a non-illustrated touch panel provided on the screen of the display unit 46. The user can perform an operation input to the control device 34 via the operation unit 48.

When the pressure detected by the pressure sensor 30A is within the normal pressure range and the flow rate detected by the flow sensor 30B is within the normal flow rate range, the determination unit 42 can determine that the pressurized fluid supply system 10 is normal. In such a case, the display control unit 44 displays no message on the display screen of the display unit 46.

There may be a case where the pressure detected by the pressure sensor 30A is within the normal pressure range while the flow rate detected by the flow sensor 30B is outside the normal flow rate range. The cause of occurrence of the above case where the pressure detected by the pressure sensor 30A is within the normal pressure range while the flow rate detected by the flow sensor 30B is outside the normal flow rate range may be, for example, that the support unit 14 (static pressure bearing) is subjected to clogging. Therefore, when the pressure detected by the pressure sensor 30A is within the normal pressure range while the flow rate detected by the flow sensor 30B is outside the normal flow rate range, the determination unit 42 can determine that an abnormality has occurred in the support unit 14. In such a case, the display control unit 44 displays a message indicating that an abnormality has occurred in the support unit 14 on the display screen of the display unit 46.

There may be a case where the pressure detected by the pressure sensor 30A is outside the normal pressure range while the flow rate detected by the flow sensor 30B is within the normal flow rate range. The cause of occurrence of the above case where the pressure detected by the pressure sensor 30A is outside the normal pressure range while the flow rate detected by the flow sensor 30B is within the normal flow rate range may be, for example, that leakage of the pressurized fluid occurs in the fluid supply path 12. Therefore, when the pressure detected by the pressure sensor 30A is outside the normal pressure range while the flow rate detected by the flow sensor 30B is within the normal flow rate range, the determination unit 42 can determine that an abnormality has occurred in the supply of the pressurized fluid to the support unit 14. In such a case, the display control unit 44 displays a message indicating that an abnormality has occurred in the supply of the pressurized fluid to the support unit 14, on the display screen of the display unit 46.

There may be a case where the pressure detected by the pressure sensor 30A is outside the normal pressure range and the flow rate detected by the flow sensor 30B is outside the normal flow rate range. In the case where the pressure detected by the pressure sensor 30A is out of the normal pressure range and the flow rate detected by the flow sensor 30B is also out of the normal flow rate range, it is difficult to specify the failure location. Therefore, when the pressure detected by the pressure sensor 30A is out of the normal pressure range and the flow rate detected by the flow sensor 30B is out of the normal flow rate range, the determination unit 42 can make a determination as follows. That is, in such a case, the determination unit 42 can determine that an abnormality has occurred in at least one of the supply of the pressurized fluid to the support unit 14 or the support unit 14. In such a case, the display control unit 44 displays, on the display screen of the display unit 46, a message indicating that an abnormality has occurred in the supply of the pressurized fluid to the support unit 14 or in the support unit 14.

FIG. 5 is a flowchart showing an example of operation of the pressurized fluid supply system according to the present embodiment.

In step S11, the determination unit 42 determines whether or not the pressure detected by the pressure sensor 30A is within the normal pressure range. When the pressure detected by the pressure sensor 30A is within the normal pressure range (YES in step S11), the process proceeds to step S12. When the pressure detected by the pressure sensor 30A is outside the normal pressure range (NO in step S11), the process proceeds to step S13.

In step S12, the determination unit 42 determines whether or not the flow rate detected by the flow sensor 30B is within the normal flow rate range. When the flow rate detected by the flow sensor 30B is within the normal flow rate range (YES in step S12), the process proceeds to step S14. When the flow rate detected by the flow sensor 30B is out of the normal flow rate range (NO in step S12), the process proceeds to step S15.

In step S13, the determination unit 42 determines whether or not the flow rate detected by the flow sensor 30B is within the normal flow rate range. When the flow rate detected by the flow sensor 30B is within the normal flow rate range (YES in step S13), the process proceeds to step S16. When the flow rate detected by the flow sensor 30B is out of the normal flow rate range (NO in step S13), the process proceeds to step S17.

In step S14, the determination unit 42 determines that the pressurized fluid supply system 10 is normal. Thereafter, the process proceeds to step S18.

In step S15, the determination unit 42 determines that an abnormality has occurred in the support unit 14. Thereafter, the process proceeds to step S19.

In step S16, the determination unit 42 determines that an abnormality has occurred in the supply of the pressurized fluid to the support unit 14. Thereafter, the process proceeds to step S20.

In step S17, the determination unit 42 determines that an abnormality has occurred in at least one of the supply of the pressurized fluid to the support unit 14 or the support unit 14. Thereafter, the process proceeds to step S21.

In step S18, the display control unit 44 displays no message on the display screen of the display unit 46.

In step S19, the display control unit 44 displays a message indicating that an abnormality has occurred in the support unit 14 on the display screen of the display unit 46. More specifically, the display control unit 44 displays, for example, a message “A problem has occurred in the bearing unit.” on the display screen of the display unit 46.

In step S20, the display control unit 44 displays a message indicating that an abnormality has occurred in the supply of the pressurized fluid to the support unit 14, on the display screen of the display unit 46. More specifically, the display control unit 44 displays, for example, a message “A problem has occurred in the air supply to the bearing unit.” on the display screen of the display unit 46.

In step S21, the display control unit 44 displays, on the display screen of the display unit 46, a message indicating that an abnormality has occurred in at least one of the supply of the pressurized fluid to the support unit 14 or the support unit 14. More specifically, the display control unit 44 displays, for example, a message “A problem has occurred in air supply to the bearing unit or in the bearing unit.” on the display screen of the display unit 46. In this manner, the process shown in FIG. 5 is brought to an end.

As described above, according to the present embodiment, the details of the abnormality are determined based on the pressure detected by the pressure sensor 30A and the flow rate detected by the flow sensor 30B. According to the present embodiment, by displaying the message indicating the details of the abnormality on the display unit 46, it is possible to cause the user to grasp the details of the abnormality.

### Third Embodiment

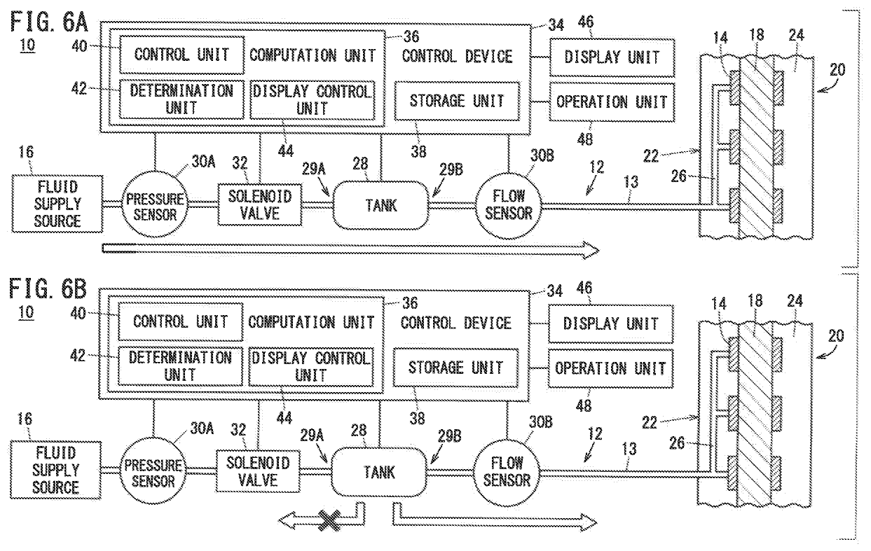

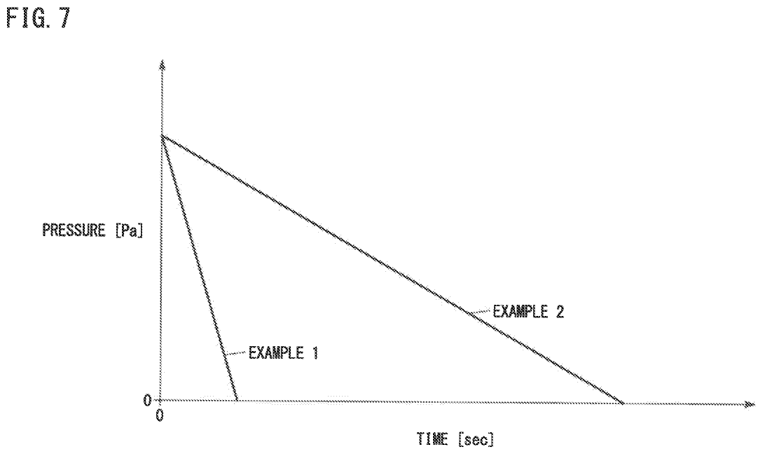

A pressurized fluid supply system according to a third embodiment will be described with reference to FIGS. 6A to 7. The same constituent elements as those of the pressurized fluid supply system according to the first or second embodiment shown in FIGS. 1 to 5 are denoted by the same reference numerals, and description thereof will be omitted or referred to in an abbreviated manner. FIGS. 6A and 6B are block diagrams illustrating the pressurized fluid supply system according to the present embodiment. FIG. 6A shows a state where the pressurized fluid is normally supplied from the fluid supply source 16 to the fluid supply path 12. FIG. 6B shows a state in which the supply of the pressurized fluid from the fluid supply source 16 to the fluid supply path 12 is disrupted. Arrows in FIGS. 6A and 6B schematically show the flow of the pressurized fluid.

In the pressurized fluid supply system 10 according to the present embodiment, a tank 28 for storing pressurized fluid is provided on the fluid supply path 12 between the solenoid valve 32 and the flow sensor 30B.

The capacity of the tank 28 is set to be sufficiently larger than the inner volume of the pipe 13 constituting the fluid supply path 12. The capacity of the tank 28 is, for example, about 5 liters, but is not limited thereto. The tank 28 includes, for example, an opening 29A and an opening 29B. In the example shown in FIG. 6A, one opening 29A of the tank 28 is connected to the solenoid valve 32 via the pipe 13, and the other opening 29B of the tank 28 is connected to the flow sensor 30B via the pipe 13. Reference numeral 29 is used to express the openings collectively, and reference numerals 29A and 29B are used to describe the individual openings.

When the pressurized fluid from the fluid supply source 16 is normally supplied to the fluid supply path 12, the pressurized fluid flows through the fluid supply path 12 as shown in FIG. 6A.

When the supply of the pressurized fluid from the fluid supply source 16 to the fluid supply path 12 is disrupted, the detection value detected by the sensor 30 is out of the normal range, and the solenoid valve 32 is closed by the control unit 40. When the solenoid valve 32 is closed, as shown in FIG. 6B, the pressurized fluid stored in the tank 28 does not flow toward the fluid supply source 16. Therefore, according to the present embodiment, when the supply of the pressurized fluid from the fluid supply source 16 to the fluid supply path 12 is disrupted, the pressurized fluid stored in the tank 28 can be sufficiently supplied to the support unit 14 via the pipe 13.

In the example shown in FIG. 6B, that is, in the present embodiment, the pressure sensor 30A, the solenoid valve 32, the tank 28, and the flow sensor 30B are arranged in this order from the upstream side to the downstream side. When the supply of the pressurized fluid from the fluid supply source 16 to the fluid supply path 12 is disrupted, the pressurized fluid stored in the tank 28 is sufficiently supplied to the support unit 14 via the pipe 13, and the flow rate is detected by the flow sensor 30B.

FIG. 7 is a graph showing an evaluation result. The horizontal axis of FIG. 7 indicates the time that elapses after the supply of the pressurized fluid from the fluid supply source 16 to the fluid supply path 12 has been disrupted. The vertical axis of FIG. 7 represents the pressure of the pressurized fluid supplied to the support unit 14. Example 1 in FIG. 7 shows a case of the first embodiment, that is, the case where the tank 28 is not provided on the fluid supply path 12 between the solenoid valve 32 and the support unit 14. Example 2 in FIG. 7 shows the case of the present embodiment, that is, the case where the tank 28 is provided in the fluid supply path 12 between the solenoid valve 32 and the support unit 14.

As can be seen from FIG. 7, in Example 2, that is, in the case of the present embodiment, after the supply of the pressurized fluid from the fluid supply source 16 to the fluid supply path 12 is disrupted, the pressure of the pressurized fluid supplied to the support unit 14 maintains a sufficiently high pressure for an extremely long time.

As described above, according to the present embodiment, the tank 28 is provided between the solenoid valve 32 and the support unit 14, and when the supply of the pressurized fluid from the fluid supply source 16 to the fluid supply path 12 is disrupted, the solenoid valve 32 is closed. Therefore, according to the present embodiment, when the supply of the pressurized fluid from the fluid supply source 16 is disrupted, the pressurized fluid stored in the tank 28 continues to be supplied to the support unit 14 via the pipe 13 for a long time. For this reason, according to the present embodiment, it is possible to sufficiently prevent a sudden pressure drop of the pressurized fluid used to support the member 18, and it is possible to sufficiently lengthen the length of time that elapses before the pressurized fluid excessively decreases in pressure. Since the length of time before the pressurized fluid excessively decreases in pressure can be sufficiently lengthened, according to the present embodiment, the rotating movement, sliding movement, or the like of the member 18 can be more reliably stopped before the pressurized fluid excessively decreases in pressure. Therefore, according to the present embodiment, even if the supply of the pressurized fluid from the fluid supply source 16 to the fluid supply path 12 is disrupted, it is possible to reliably prevent damage to the member 18 supported by using the pressurized fluid.

### Modified Examples

Although preferred embodiments of the present invention have been described above, the present invention is not limited to the above-described embodiments, and various modifications can be made thereto within a range that does not depart from the essence and gist of the present invention.

For example, in the third embodiment, the case where the tank 28 is provided with the two openings 29A and 29B has been described as an example, but the present invention is not limited thereto. The tank 28 may be provided with only one opening 29. In such a case, a branch pipe (not shown) branching from the pipe 13 may be connected to one opening 29 of the tank 28. Also in the case where the branch pipe branching from the pipe 13 is connected to the tank 28, it can be said that the tank 28 is provided on the fluid supply path 12. Even in the case where the branch pipe branching from the pipe 13 is connected to the tank 28, when the supply of the pressurized fluid from the fluid supply source 16 to the fluid supply path 12 is disrupted, the pressurized fluid stored in the tank 28 continues to be supplied to the support unit 14 for a long time. Therefore, even in such a configuration, it is possible to sufficiently increase the length of time that elapses before the pressurized fluid excessively decreases in pressure.

In the above-described embodiments, the case where the support unit 14, the member 18, and the like are provided on the spindle 22 has been described as an example, but the present invention is not limited thereto. The support unit 14, that is, the static pressure bearing, may be provided in a linear motion mechanism (not illustrated). The member 18 may be a shaft constituting part of such a linear motion mechanism. Such a linear motion mechanism can be provided in a balancer device, for example, but is not limited thereto. Such a balancer device serves for reducing the gravity acting on a slider (not shown), for example.

The above-described embodiments may be summarized in the following manner.

The pressurized fluid supply system (10) includes: the fluid supply path (12) configured to allow a pressurized fluid from the fluid supply source (16) to be supplied to the support unit (14) configured to support the member (18) using the pressurized fluid; the solenoid valve (32) provided on the fluid supply path; the pressure sensor (30A) provided on the fluid supply path between the fluid supply source and the solenoid valve and configured to detect the pressure of the pressurized fluid; the flow sensor (30B) provided on the fluid supply path between the solenoid valve and the support unit and configured to detect the flow rate of the pressurized fluid; and the control unit (40) configured to control opening and closing of the solenoid valve. According to such a configuration, since the pressure sensor is positioned between the fluid supply source and the solenoid valve, the pressure sensor can detect whether or not the supply of the pressurized fluid from the fluid supply source has returned to normal. When the supply of the pressurized fluid from the fluid supply source has returned to normal, the pressure detected by the pressure sensor falls within the normal pressure range. Of the sensors, only the pressure sensor is located upstream of the solenoid valve. That is, in such a configuration, there is no sensor whose detection value is out of the normal range even though the supply of the pressurized fluid from the fluid supply source has returned to normal, on the upstream side of the solenoid valve. Therefore, in the configuration, if the supply of the pressurized fluid from the fluid supply source returns to normal after closing of the solenoid valve, the solenoid valve is opened. When the solenoid valve is opened, the flow rate of the pressurized fluid detected by the flow sensor falls within the normal flow rate range. As described above, in this configuration, if the supply of the pressurized fluid from the fluid supply source returns to normal after closing of the solenoid valve, the solenoid valve is opened and the supply of the pressurized fluid to the support unit can be suitably resumed. As described above, according to this configuration, it is possible to provide the pressurized fluid supply system in which the supply of the pressurized fluid to the support unit can be satisfactorily resumed when the supply of the pressurized fluid from the fluid supply source has returned to normal.

The pressurized fluid supply system may further include the determination unit (42) configured to determine whether or not an abnormality has occurred based on the pressure of the pressurized fluid detected by the pressure sensor and the flow rate of the pressurized fluid detected by the flow sensor, and the control unit may close the solenoid valve when the determination unit determines that the abnormality has occurred.

When the pressure of the pressurized fluid is within a normal pressure range and the flow rate of the pressurized fluid is outside a normal flow rate range, the determination unit may determine that the abnormality has occurred in the support unit. According to such a configuration, it is possible to grasp the details of the abnormality.

When the pressure of the pressurized fluid is outside a normal pressure range and the flow rate of the pressurized fluid is within a normal flow rate range, the determination unit may determine that the abnormality has occurred in supply of the pressurized fluid to the support unit. According to such a configuration, it is possible to grasp the details of the abnormality.

When the pressure of the pressurized fluid is outside a normal pressure range and the flow rate of the pressurized fluid is outside a normal flow rate range, the determination unit may determine that the abnormality has occurred in at least one of the support unit or supply of the pressurized fluid to the support unit. According to such a configuration, it is possible to grasp the details of the abnormality.

The pressurized fluid supply system may further include a tank (28) provided on the fluid supply path between the solenoid valve and the support unit and configured to store the pressurized fluid. According to such a configuration, when the supply of the pressurized fluid from the fluid supply source is disrupted, the solenoid valve is closed, and the pressurized fluid stored in the tank continues to be supplied to the support unit via the pipe for a long period of time. For this reason, according to the configuration, it is possible to sufficiently prevent a sudden pressure drop of the pressurized fluid used to support the member, and it is possible to sufficiently lengthen the length of time that elapses before the pressurized fluid excessively decreases in pressure. The length of time that elapses before the pressurized fluid excessively decreases in pressure can be made sufficiently long, and thus, according to this configuration, it is possible to more reliably stop rotating movement, sliding movement, or the like of the member before the pressurized fluid excessively decreases in pressure. Therefore, in this configuration, even if the supply of the pressurized fluid from the fluid supply source to the fluid supply path is disrupted, it is possible to reliably prevent the member supported by using the pressurized fluid from being damaged.

The support unit may be a static pressure bearing configured to rotatably or slidably support the member using the pressurized fluid.

1. A pressurized fluid supply system comprising:
a fluid supply path configured to allow a pressurized fluid from a fluid supply source to be supplied to a support unit configured to support a member using the pressurized fluid;
a solenoid valve provided on the fluid supply path;
a pressure sensor provided on the fluid supply path between the fluid supply source and the solenoid valve and configured to detect a pressure of the pressurized fluid;
a flow sensor provided on the fluid supply path between the solenoid valve and the support unit and configured to detect a flow rate of the pressurized fluid; and
a control unit configured to control opening and closing of the solenoid valve.

2. The pressurized fluid supply system according to claim 1, further comprising:
a determination unit configured to determine whether or not an abnormality has occurred based on the pressure of the pressurized fluid detected by the pressure sensor and the flow rate of the pressurized fluid detected by the flow sensor,
wherein the control unit closes the solenoid valve when the determination unit determines that the abnormality has occurred.

3. The pressurized fluid supply system according to claim 2, wherein
when the pressure of the pressurized fluid is within a normal pressure range and the flow rate of the pressurized fluid is outside a normal flow rate range, the determination unit determines that the abnormality has occurred in the support unit.

4. The pressurized fluid supply system according to claim 2, wherein
when the pressure of the pressurized fluid is outside a normal pressure range and the flow rate of the pressurized fluid is within a normal flow rate range, the determination unit determines that the abnormality has occurred in supply of the pressurized fluid to the support unit.

5. The pressurized fluid supply system according to claim 2, wherein
when the pressure of the pressurized fluid is outside a normal pressure range and the flow rate of the pressurized fluid is outside a normal flow rate range, the determination unit determines that the abnormality has occurred in at least one of the support unit or supply of the pressurized fluid to the support unit.

6. The pressurized fluid supply system according to claim 1, further comprising:
a tank provided on the fluid supply path between the solenoid valve and the support unit and configured to store the pressurized fluid.

7. The pressurized fluid supply system according to claim 1, wherein
the support unit is a static pressure bearing configured to rotatably or slidably support the member using the pressurized fluid.
